(19) United States
(12) Patent Application Publication
(10) Pub. No.: US 2010/0325638 A1
(43) Pub. Date: Dec. 23, 2010

(54) INFORMATION PROCESSING APPARATUS, AND RESOURCE MANAGING METHOD AND PROGRAM

(76) Inventor: Hisashi NISHIMAKI, Kanagawa (JP)

Correspondence Address: FROMMER LAWRENCE & HAUG LLP, 745 FIFTH AVENUE, NEW YORK, NY, 10151, US

(21) Appl. No.: 12/815,857

(22) Filed: Jun. 15, 2010

(30) Foreign Application Priority Data
Jun. 23, 2009 (JP) P2009-148786

(51) Int. Cl. G06F 9/50

(52) U.S. Cl. 718/104

(57) ABSTRACT

An information processing apparatus includes: a resource manager that allocates a resource in response to a codec processing request from an application, wherein the resource manager has first information indicating the relationship between codec processing functions and resources and second information indicating the availability of the resources, and the resource manager identifies resources having the codec processing function corresponding to the codec processing request from the application based on the first information, selects an idle resource from the identified resources based on the second information, and allocates the idle resource.

### BACKGROUND OF THE INVENTION

1. Field of the Invention

The present invention relates to an information processing apparatus, and a resource managing method and program, and particularly to a technology for readily managing resources in response to a codec processing request from an application.

2. Description of the Related Art

In recording/reproducing, communicating, or otherwise processing an information signal, such as video data and audio data, a variety of methods have been used to encode and decode the information signal.

To encode and decode such an information signal, in JP-A-2006-31337, for example, a server refers to information on resources necessary to decode content data and identifies an optimum codec capable of decoding the content data in a recording/reproducing apparatus. Further, the content data processed by the codec is selected from stored content data and sent to the recording/reproducing apparatus. When the recording/reproducing apparatus does not include the identified optimum codec, the server sends a decoding program along with the information signal to the recording/reproducing apparatus.

### SUMMARY OF THE INVENTION

When a recording/reproducing apparatus, a server, or any other apparatus is used to encode and decode video, audio, or any other data, the availability of each resource needs to be managed, for example, to allocate an idle resource. When an application performs such resource management, however, the development of the application and processes in the application become complicated because resources need to be managed for each application, resulting in difficulty in allocating resources and other operations.

Thus, it is desirable to provide an information processing apparatus, and a resource managing method and program capable of readily performing resource management, such as resource allocation.

A first embodiment of the invention is directed to an information processing apparatus including a resource manager that allocates a resource in response to a codec processing request from an application. The resource manager has first information indicating the relationship between codec processing functions and resources and second information indicating the availability of the resources. The resource manager identifies resources having the codec processing function corresponding to the codec processing request from the application based on the first information, selects an idle resource from the identified resources based on the second information, and allocates the idle resource.

In the embodiment of the invention, the resource manager has first information indicating the relationship between codec processing functions and resources and second information indicating the availability of the resources, and the resource manager identifies resources having the codec processing function corresponding to a codec processing request from an application based on the first information. The resource manager further calculates a priority for each of the resources in consideration of a response time and a resource occupied period. The resource manager gives a higher priority to a resource the response time of which is shorter, and gives a higher priority to a resource the occupied period of which is shorter. The resource manager further calculates the priority of a software resource by using a load factor in software processing and gives a higher priority to a resource the load factor of which is lower. The resource manager selects idle resources based on the second information from the resources identified based on the first information, and allocates an idle resource having the highest priority. Further, the resource manager updates the second information when the resource is allocated.

The resource manager further has third information indicating a command execution status in the allocated resource. When the application issues a resource freeing request, the resource manager frees the resource allocated to the application after the third information indicates that the command execution is completed. Further, the resource manager updates the third information when the allocated resource notifies the resource manager that the command execution is completed, and updates the second information when the resource allocated to the application is freed.

Moreover, the resource manager uses a resource controller to control the allocated resource to perform the codec processing in response to the codec processing request from the application. In this way, the resource manager masks the control of the resource from the application.

A second embodiment of the invention is directed to a resource managing method that instructs a resource manager to perform the steps of identifying resources having a codec processing function corresponding to a codec processing request from an application based on first information indicating the relationship between codec processing functions and resources, and selecting an idle resource from the identified resources based on second information indicating the availability of the resources and allocating the idle resource.

A third embodiment of the invention is directed to a program that causes an information processing apparatus to function as function means for identifying resources having a codec processing function corresponding to a codec processing request from an application based on first information indicating the relationship between codec processing functions and resources, and function means for selecting an idle resource from the identified resources based on second information indicating the availability of the resources and allocating the idle resource.

The program according to the third embodiment of the invention is, for example, a program that can be provided to an information processing apparatus that can execute a variety of program codes in the form of a storage medium, such as an optical disk, magnetic disk, and a semiconductor memory, or a communication medium, such as a network, formatted to be readable by the information processing apparatus. Providing such a program in a readable format allows the information processing apparatus to carry out processes according to the program.

According to the first embodiment of the invention, the resource manager identifies resources having a codec processing function corresponding to a codec processing request from an application based on the first information indicating the relationship between codec processing functions and resources. Further, the resource manager selects an idle resource from the identified resources based on the second information indicating the availability of the resources, and allocates the idle resource.

Therefore, an idle resource can be automatically allocated irrespective of whether the type of resource is, for example, a hardware resource or a software resource. Further, at the time of resource fetching, although an application does not know the availability of the resources, a resource can be allocated, whereby the resource management can be readily carried out.

### BRIEF DESCRIPTION OF THE DRAWINGS

FIG. 1 is a functional block diagram of an information processing apparatus;

FIG. 2 shows a software configuration of the information processing apparatus;

FIG. 3 shows the configuration of a resource manager;

FIG. 4 is a flowchart showing the operation of the resource manager when a resource fetching instruction has been issued;

FIG. 5 is a flowchart showing the operation of the resource manager when an encoding instruction has been issued;

FIG. 6 is a flowchart showing the operation of the resource manager after the encoding instruction has been issued to a resource;

FIG. 7 is a flowchart showing the operation of the resource manager when a resource freeing instruction has been issued; and

FIG. 8 is a flowchart showing a method for determining priorities of resources.

### DESCRIPTION OF THE PREFERRED EMBODIMENTS

An embodiment for implementing the invention will be described below. The description will be made in the following order:

1. Configuration of information processing apparatus

2. Resource managing operation

### <1. Configuration of Information Processing Apparatus>

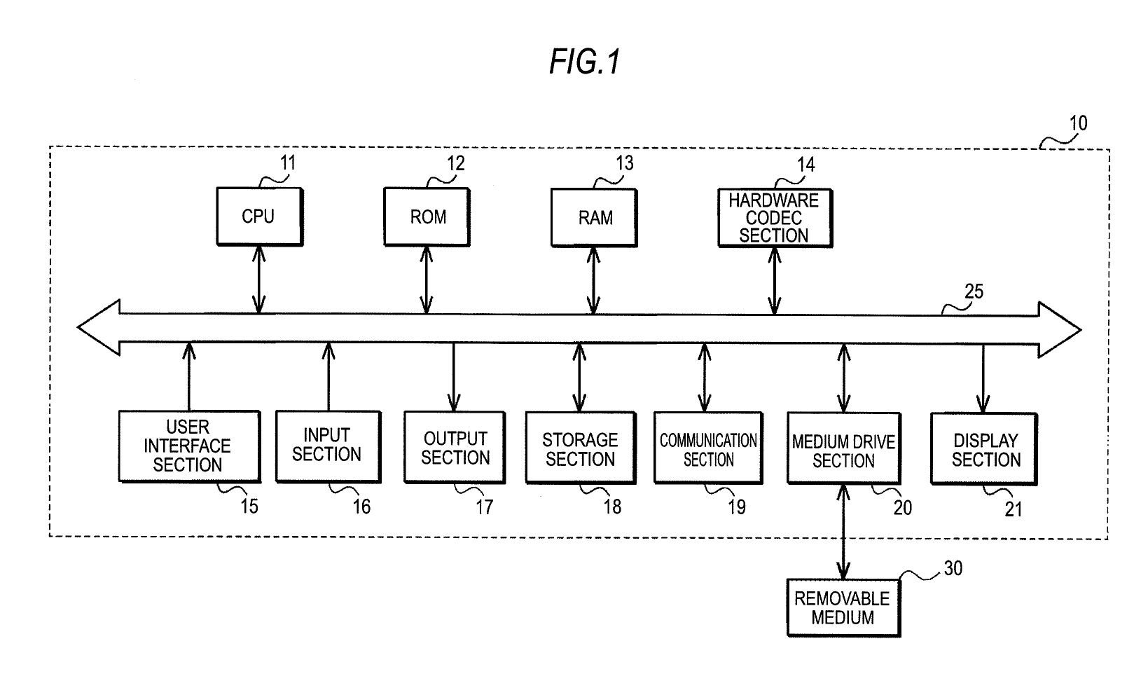

FIG. 1 is a functional block diagram of an information processing apparatus according to an embodiment of the invention. An information processing apparatus 10 includes a CPU (Central Processing Unit) 11, a ROM (Read Only Memory) 12, a RAM (Random Access Memory) 13, and a hardware codec section 14. The information processing apparatus 10 further includes a user interface section 15, an input section 16, an output section 17, a storage section 18, a communication section 19, a medium drive section 20, and a display section 21. The components in the information processing apparatus 10 are connected to one another via a bus 25.

The CPU 11 carries out a variety of processes in accordance with a program stored in the ROM 12 or the storage section 18. For example, various pieces of information for carrying out a variety of applications and resource management are created, updated, and otherwise processed.

The RAM 13 stores as appropriate, for example, programs performed by the CPU 11 and data used by the CPU 11.

The hardware codec section 14 encodes and decodes an information signal. The hardware codec section 14 is formed of one or more hardware codecs that perform encoding and decoding.

The user interface section 15 is formed of a keyboard, a pointing device, a remote control signal transceiver, and other components and outputs an operation signal according to a user operation to the CPU 11.

The input section 16 converts an information signal, such as an image signal and an audio signal, supplied from an external apparatus (not shown) into data processable by the information processing apparatus 10. The output section 17 converts an information signal to be outputted to the external apparatus into data suitable for the external apparatus and outputs the converted data.

The storage section 18 is formed of an HDD (Hard Disk Drive), an SSD (Solid State Drive), or any other suitable storage device. The storage section 18 stores programs, for example, applications, APIs (Application Program Interfaces), device drivers, and software codecs executed by the CPU 11. The storage section 18 further stores as necessary information signals, such as video data and audio data.

The communication section 19 connects the information processing apparatus 10 to, for example, an external network, and the information processing apparatus 10 communicates with other apparatus on the network via the communication section 19. A variety of data, programs, and other information acquired from other apparatus via the communication section 19 are stored, for example, in the RAM 13 or the storage section 18 and read by the CPU 11 as necessary. When the ROM 12 is a rewritable device, a program acquired via the communication section 19 is used to update programs stored in the ROM 12 in some cases.

The medium drive section 20 reads a variety of data, programs, and other information recorded on a loaded removable medium 30, such as a magnetic disk, an optical disk, a magneto-optical disk, and a semiconductor memory. A program having been read is processed in the same manner as a program acquired via the communication section 19 is processed.

The display section 21 is formed of a display device such as a liquid crystal panel and displays various pieces of information to a user. For example, when the CPU 11 supplies display information to the display section 21 in accordance with a variety of operation statuses, input statuses, and communication statuses, the display section 21 drives the display device based on the display information to display, for example, the operation statuses.

The information processing apparatus 10 is not necessarily configured as shown in the functional block diagram in FIG. 1, as long as it have any configuration that includes hardware codecs, software codecs, and APIs.

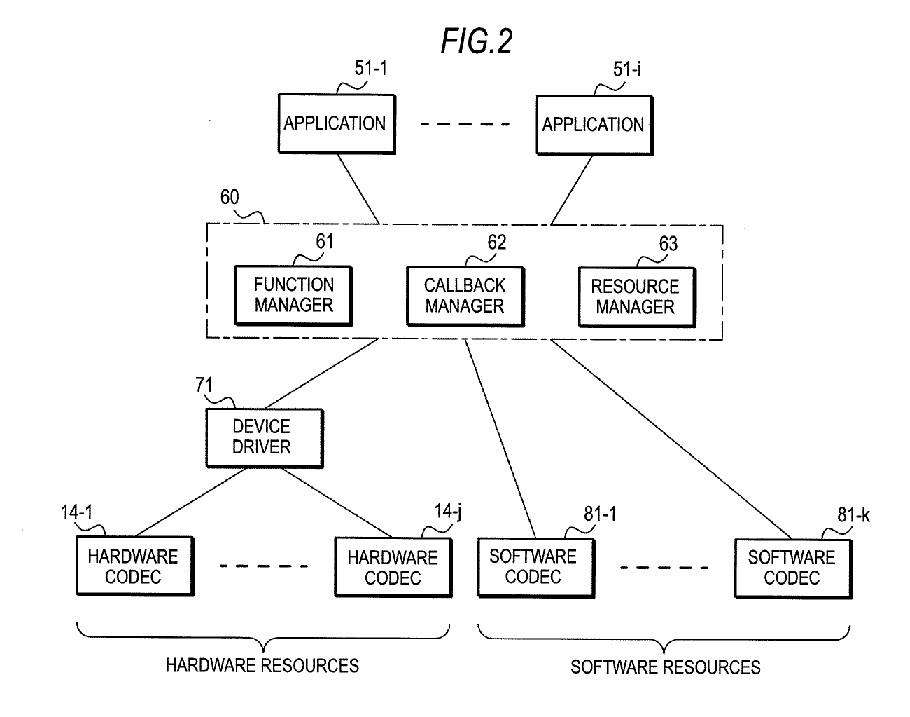

FIG. 2 shows a software configuration of the information processing apparatus. The information processing apparatus 10 includes a group of software formed of applications 51-1 to 51-i, an API (Application Program Interface) 60, and a device driver 71. The information processing apparatus 10 further includes hardware codecs 14-1 to 14-j, each of which is formed of hardware and encodes and decodes an information signal, and software codecs 81-1 to 81-k, each of which is formed of software and encodes and decodes an information signal.

The applications 51-1 to 51-i are programs for recoding, reproducing, editing, or otherwise processing an information signal. The applications 51-1 to 51-i, when encoding or decoding an information signal in a recoding, reproducing, editing, or otherwise processing operation, outputs a codec processing request, such as a resource fetching instruction, an encoding instruction, or a decoding instruction. Further, the applications 51-1 to 51-i, when terminating the encoding or decoding of the information signal, outputs a resource freeing instruction. It is noted that the number of applications is not necessarily plural but may be one.

The API 60 interprets or otherwise process instructions outputted from the applications 51-1 to 51-i to perform resource management and automatic switching. For example, the API 60 allocates or frees a resource, such as a hardware codec and a software codec, in accordance with the resource occupancy status. The API 60 also distributes or issues an encoding or decoding instruction to the allocated resources or resource.

The API 60 includes a function manager 61, a callback manager 62, and a resource manager 63.

The function manager 61 manages a function and other information that allows available hardware and software codecs to be identified and makes the identified codecs available to the applications 51-1 to 51-i.

The callback manager 62, after an application makes a processing request to a hardware or software codec, manages a return value sent in response to the processing request.

The resource manager 63 uses the function and information under the management of the function manager 61 and the callback manager 62 to perform resource management, specifically, manage hardware and software codecs, which are hardware and software resources, respectively. The resource manager 63 also provides an optimum resource and frees a resource in response to a resource fetching instruction and a resource freeing instruction from the applications 51-1 to 51-i.

Each of the hardware codecs 14-1 to 14j and the software codecs 81-1 to 81-k is a resource that encodes and decodes an information signal. Each of the hardware codecs 14-1 to 14j and the software codecs 81-1 to 81-k may be a codec that performs either encoding or decoding or a codec that performs both of encoding and decoding. Further, the hardware codecs 14-1 to 14j and the software codecs 81-1 to 81-k may operate based on the same scheme or different schemes.

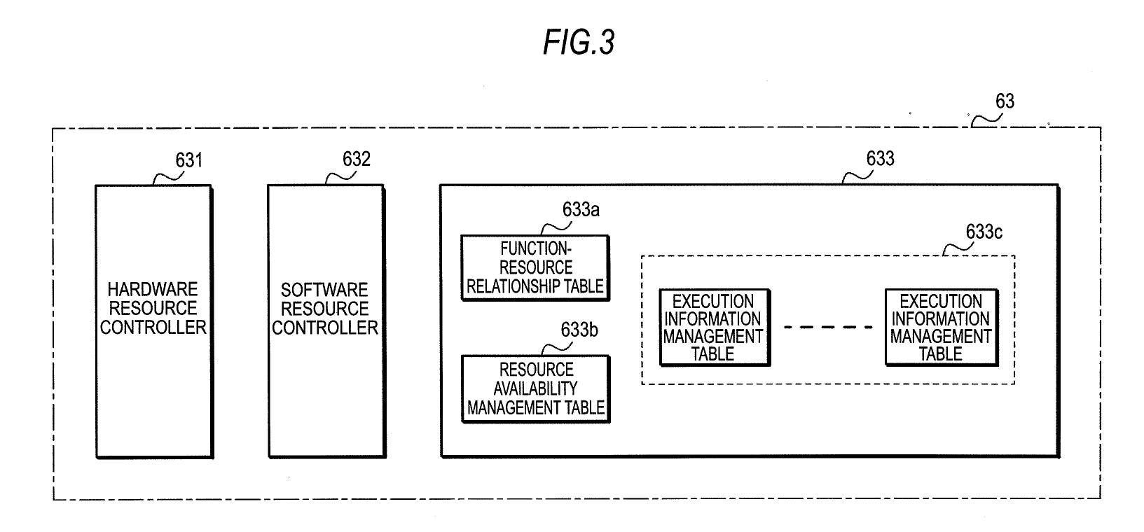

FIG. 3 shows the configuration of the resource manager. The resource manager 63 includes a hardware resource controller 631, a software resource controller 632, and a control manager 633.

The hardware resource controller 631 provides an interface between the hardware resources and the applications. The software resource controller 632 provides an interface between the software resources and the applications. The hardware resource controller 631 and the software resource controller 632 control a hardware or software resource in response to an encoding instruction or a decoding instruction from an application to instruct the resource to perform encoding or decoding.

As described above, operating a resource via the hardware resource controller 631 or the software resource controller 632 allows the resource manager 63 to mask the control of the resource from higher-level applications and allows each application to perform encoding and decoding via a common interface.

The control manager 633 has first information indicating the relationship between codec processing functions and resources, for example, a function-resource relationship table 633a. The control manager 633 further has second information indicating resource availability, for example, a resource availability management table 633b. The control manager 633 further has third information indicating a command execution status in an allocated resource, for example, an execution information management table 633c.

When any of the applications 51-1 to 51-i makes a codec processing request, the control manager 633 identifies resources having the codec processing function corresponding to the codec processing request based on the function-resource relationship table 633a. The control manager 633 selects an idle resource from the identified resources based on the resource availability management table 633b and allocates the selected idle resource to the application having made the codec processing request.

The function-resource relationship table 633a shows the relationship between codec processing functions and resources, as described above. For example, the information processing apparatus 10 includes, as hardware resources, the hardware codec 14-1 capable of performing encoding and decoding based on a MPEG (Moving Picture Experts Group)-2 scheme and the hardware codec 14-2 capable of performing encoding and decoding based on a MPEG-4 scheme. The information processing apparatus 10 further includes, as software resources, the software codec 81-1 capable of performing encoding and decoding based on the MPEG-2 scheme and the software codec 81-2 capable of performing only decoding based on the MPEG-4 scheme. In this case, the function-resource relationship table 633a is expressed as Table 1. In Table 1, the function ID represents an identification value allocated to a codec processing function name.

TABLE 1
633a

| Function ID | Function Name | Necessary Resource |
|---|---|---|
| 1 | MPEG-2 encoding | Hardware codec 14-1 |
| | | or |
| | | Software codec 81-1 |
| 2 | MPEG-2 decoding | Hardware codec 14-1 |
| | | or |
| | | Software codec 81-1 |
| 3 | MPEG-4 encoding | Hardware codec 14-2 |
| 4 | MPEG-4 decoding | Hardware codec 14-2 |
| | | or |
| | | Software codec 81-2 |

The function ID “1” in Table 1 indicates that the hardware codec 14-1 or the software codec 81-1 is necessary to perform encoding based on the MPEG-2 scheme. The function ID “2” indicates that the hardware codec 14-1 or the software codec 81-1 is necessary to perform decoding based on the MPEG-2 scheme. The function ID “3” indicates that the hardware codec 14-2 is necessary to perform encoding based on the MPEG-4 scheme. The function ID “4” indicates that the hardware codec 14-2 or the software codec 81-2 is necessary to perform decoding based on the MPEG-4 scheme.

The resource availability management table 633b indicates the availability of resources. The information processing apparatus 10 includes the hardware codecs 14-1 and 14-2 and the software codecs 81-1 and 81-2, as described above.

It is now assumed that, for example, the application 51-1 uses the hardware codec 14-1 and the application 51-2 uses the hardware codec 14-2 in the information processing apparatus 10. In this case, the resource availability management table 633b is expressed as Table 2.

TABLE 2
633b

| | Achievable | | |
|---|---|---|---|
| Resource Name | Function ID | Occupancy Status | Priority |
| Hardware codec 14-1 | 1, 2 | Application 51-1 | 9 |
| Hardware codec 14-2 | 3, 4 | Application 51-2 | 8 |
| Software codec 81-1 | 1, 2 | | 1 |
| Software codec 81-2 | 4 | | 2 |

Table 2 indicates that the hardware codec 14-1 can perform the function IDs “1 and 2,” that is, encoding and decoding based on the MPEG-2 scheme. Table 2 further indicates that the hardware codec 14-1 is occupied by the application 51-1.

Table 2 also indicates that the hardware codec 14-2 can perform the function IDs “3 and 4,” that is, encoding and decoding based on the MPEG-4 scheme. Table 2 further indicates that the hardware codec 14-2 is occupied by the application 51-2.

Table 2 indicates that the software codec 81-1 can perform the function IDs “1 and 2,” that is, encoding and decoding based on the MPEG-2 scheme. Table 2 further indicates that the software codec 81-1 is not in use or is an idle resource.

Table 2 indicates that the software codec 81-2 can perform only the function ID “4”, that is, decoding based on the MPEG-4 scheme. Table 2 further indicates that the software codec 81-2 is an idle resource.

Further, a priority that allows an optimum resource to be selected from idle resources is set for each of the resources. The priority will be described later.

The execution information management table 633c indicates the command execution status in a resource allocated to an application. The information processing apparatus 10 includes the hardware codecs 14-1 and 14-2 and the software codecs 81-1 and 81-2, as described above.

For example, when the hardware codec 14-1 is allocated to the application 51-1 in the information processing apparatus 10, the execution information management table 633c-1 is expressed as Table 3.

TABLE 3
633c-1

| | | | Execution |
|---|---|---|---|
| Application ID | Occupied Resource | Format | Counter |
| Application 51-1 | Hardware codec 14-1 | MPEG-2 | 0 |

Table 3 indicates that the application 51-1 is performing encoding or decoding based on the MPEG-2 scheme by using the hardware codec 14-1. The execution information management table 633c further includes an execution counter. The execution counter manages the execution status of an encoding instruction or a decoding instruction. The execution counter increments the count, for example, when an instruction is issued, whereas the execution counter decrements the count when a callback function indicating that the instruction is completed is returned. The instruction execution status can therefore be managed based on the count of the execution counter.

### <2. Resource Managing Operation>

A resource managing operation carried out in the information processing apparatus 10 will be described with reference to flowcharts.

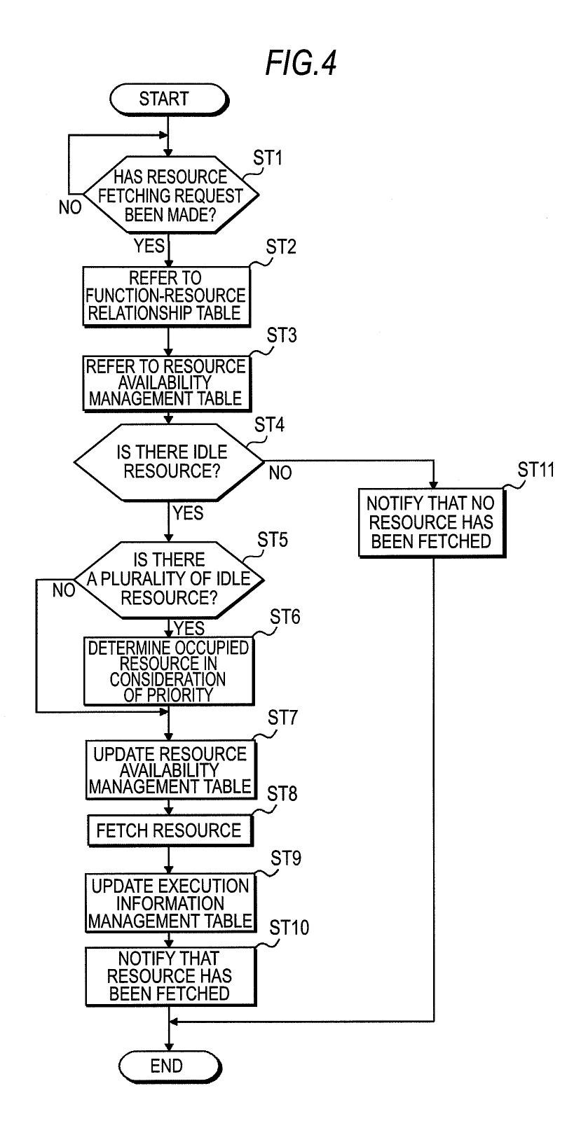

FIG. 4 shows the operation of the resource manager 63 when an application has issued a resource fetching instruction as a codec processing request. In the illustrated codec processing request, the application 51-3, for example, has issued a resource fetching instruction for performing encoding based on the MPEG-2 scheme.

In the step ST1, the resource manager 63 judges whether or not a resource fetching request has been made. When no resource fetching instruction has been issued, the resource manager 63 returns to the step ST1, whereas when a resource fetching instruction has been issued, the resource manager 63 proceeds to the step ST2.

In the step ST2, the resource manager 63 refers to the function-resource relationship table. Referring to the function-resource relationship table 633a, the resource manager 63 acquires information on the resources necessary to perform the codec processing and then proceeds to the step ST3. For example, when the codec processing is encoding based on the MPEG-2 scheme and the function-resource relationship table 633a is expressed as Table 1, the resource information acquired by the resource manager 63 is “the hardware codec 14-1 or the software codec 81-1.”

In the step ST3, the resource manager 63 refers to the resource availability management table. Referring to the resource availability management table 633b, the resource manager 63 acquires the availability of the resources indicated by the information acquired in the step ST2. For example, it is assumed that the information acquired in the step ST2 is “the hardware codec 14-1 or the software codec 81-1” and the resource availability management table 633b is expressed as Table 2. In this case, the availability of the resources acquired by the resource manager 63 is “the hardware codec 14-1 is occupied by the application 51-1” and “the software codec 81-1 is an idle resource.”

In the step ST4, the resource manager 63 judges whether or not there is any idle resource. When there is an idle resource, the resource manager 63 proceeds to the step ST5, whereas when there is no idle resource, the resource manager 63 proceeds to the step ST11.

In the step ST5, the resource manager 63 judges whether or not there is a plurality of idle resources. When there is a plurality of idle resources, the resource manager 63 proceeds to the step ST6, whereas when there is only one idle resource, the resource manager 63 allocates the idle resource as an occupied resource to the codec processing and then proceeds to the step ST7.

In the step ST6, the resource manager 63 determines an occupied resource in consideration of priority. The resource manager 63 compares priorities of the plurality of idle resources, determines the idle resource having the highest priority to be the occupied resource, and then proceeds to the step ST7.

In the step ST7, the resource manager 63 updates the resource availability management table. The resource manager 63, which has determined the occupied resource by which the codec processing is performed, updates the occupancy status of the thus determined occupied resource in the resource availability management table 633b from idle to occupied, and then proceeds to the step ST8. For example, when the application 51-3 has issued the resource fetching instruction and the “software codec 81-1” is determined to be the occupied resource, the resource manager 63 updates the resource availability management table 633b from Table 2 to Table 4.

TABLE 4
633b

| | Achievable | | |
|---|---|---|---|
| Resource Name | Function ID | Occupancy Status | Priority |
| Hardware codec 14-1 | 1, 2 | Application 51-1 | 9 |
| Hardware codec 14-2 | 3, 4 | Application 51-2 | 8 |
| Software codec 81-1 | 1, 2 | Application 51-3 | 1 |
| Software codec 81-2 | 4 | | 2 |

In the step ST8, the resource manager 63 fetches the resource. The resource manager 63 allocates the occupied resource determined in response to the resource fetching instruction from the application, and then proceeds to the step ST9.

In the step ST9, the resource manager 63 updates the execution information management tables. The resource manager 63 updates the execution information management tables based on the information on the application having issued the resource fetching instruction and the determined occupied resource and the information on the codec format, and then proceeds to the step ST10. For example, when the application 51-3 has issued the resource fetching instruction for performing encoding based on the MPEG-2 scheme and the “software codec 81-1” is determined to be the occupied resource, the resource manager 63 adds an execution information management table 633c-3 shown in Table 5. It is noted that the execution counter is set, for example, at “0” because the application 51-3 has not been notified that a resource had been fetched and hence has issued no encoding or decoding instruction.

TABLE 5
633c-3

| | | | Execution |
|---|---|---|---|
| Application ID | Occupied Resource | Format | Counter |
| Application 51-3 | Software codec 81-1 | MPEG-2 | 0 |

In the step ST10, the resource manager 63 notifies that the resource has been fetched. The resource manager 63, which has fetched the occupied resource in response to the resource fetching instruction from the application, notifies the application having issued the resource fetching instruction that the resource has been fetched.

When the judgment result in the step ST4 shows that there is no idle resource, the resource manager 63 proceeds to the step ST11, where the resource manager 63 notifies that it has failed to fetch any resource. The resource manager 63, which has failed to fetch any occupied resource in response to the resource fetching instruction from the application, notifies the application having issued the resource fetching instruction that the resource manager 63 has failed to fetch any resource.

The resource manager 63 thus attempts to fetch a resource in response to a resource fetching instruction from an application and notifies the application of the result of the attempt.

The application, when notified by the resource manager 63 that a resource has been fetched, issues a codec instruction.

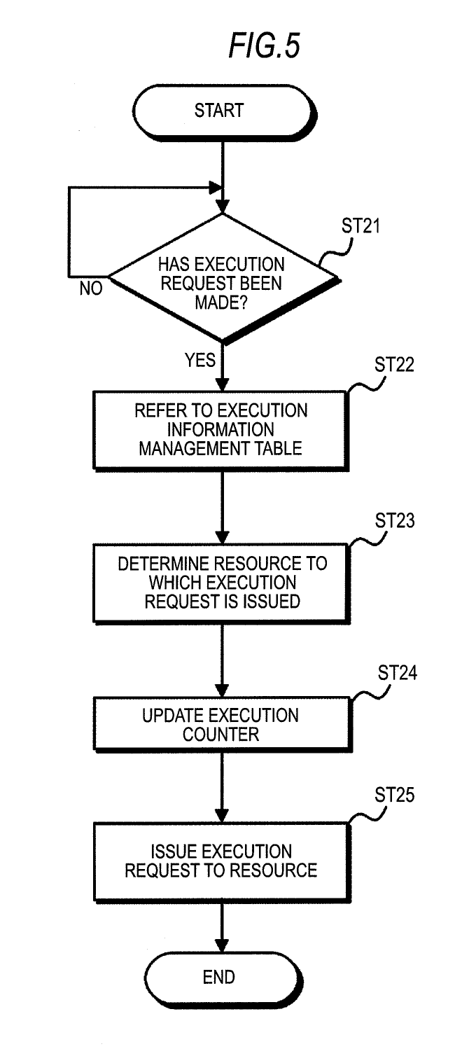

A description will next be made of the operation of the resource manager 63 when the application issues an encoding instruction or a decoding instruction as a codec processing request. FIG. 5 illustrates a case where the application 51-3 issues, for example, an encoding instruction for performing encoding based on the MPEG-2 scheme.

In the step ST21, the resource manager 63 judges whether or not an execution request has been made. When no encoding instruction, which is a codec processing execution request, has been issued, the resource manager 63 returns to the step ST21, whereas when an encoding instruction has issued, the resource manager 63 proceeds to the step ST22.

In the step ST22, the resource manager 63 refers to the execution information management tables. Referring to the execution information management tables, the resource manager 63 acquires information on the resource to which the execution request has been issued and then proceeds to the step ST23. For example, the resource manager 63 refers to the execution information management table shown in Table 5 and acquires information indicating that “software codec 81-1” has been fetched as the resource occupied by the application 51-3.

In the step ST23, the resource manager 63 determines the resource to which the execution request is issued. The resource manager 63 determines the resource indicated by the resource information acquired by referring to the execution information management table to be the resource to which the execution request is issued and then proceeds to the step ST24. For example, when the acquired resource information indicates “software codec 81-1,” the resource manager 63 determines the “software codec 81-1” to be the destination to which the encoding instruction from the application 51-3 is issued.

In the step ST24, the resource manager 63 updates the execution counter. The resource manager 63 updates the execution counter when the application issues the execution request to the execution request target resource, allowing the execution request issued status to be known. For example, the resource manager 63 increments the execution counter whenever the application 51-3 issues an encoding instruction, whereas the resource manager 63 decrements the execution counter whenever the resource notifies that the process corresponding to the encoding instruction has been completed.

In the step ST25, the resource manager 63 issues the execution request to the resource. The resource manager 63 issues the execution request from the application to the execution request target resource. For example, the resource manager 63 issues the encoding instruction from the application 51-3 to the software codec 81-1. Further, the resource manager 63 controls the software codec 81-1 via the software resource controller 632 to mask the control of the software codec 81-1 from the application 51-3. Therefore, the application 51-3 only issues the encoding instruction via a common interface, and then the software codec 81-1 performs encoding according to the encoding instruction issued from the application 51-3.

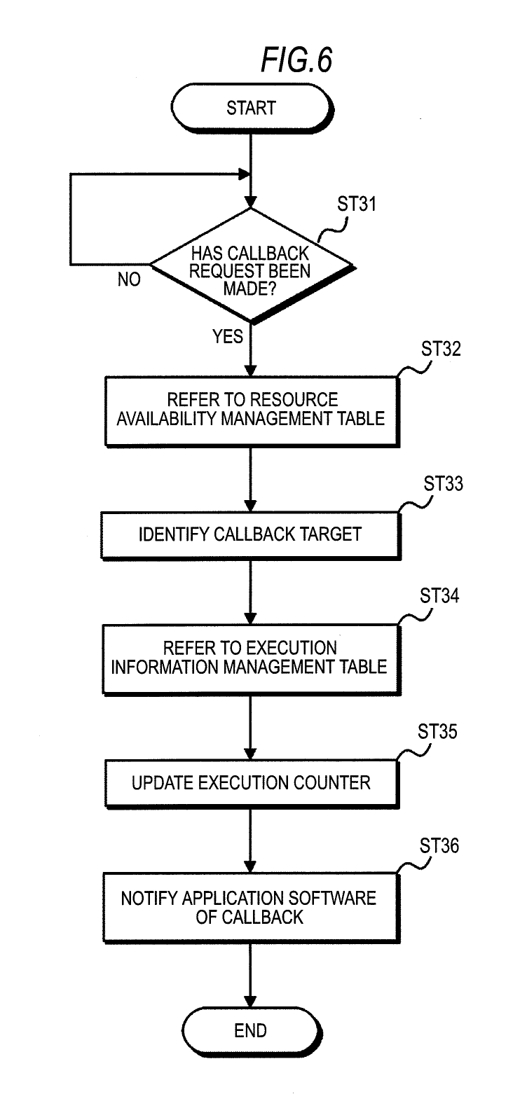

A description will next be made of the operation of the resource manager 63 after the encoding or decoding instruction from the application has been issued to the resource. FIG. 6 shows the operation of the resource manager 63, for example, after the encoding instruction from the application has been issued to the resource.

In the step ST31, the resource manager 63 judges whether or not the resource has made a callback request. When no callback request has been made, the resource manager 63 returns to the step ST31, whereas when a callback request has been made, the resource manager 63 proceeds to the step ST32.

In the step ST32, the resource manager 63 refers to the resource availability management table. Referring to the resource availability management table 633b, the resource manager 63 acquires information on the application that is using the resource having made the callback request and then proceeds to the step ST33. For example, when the resource availability management table 633b is Table 4 and the software codec 81-1 has made a callback request, the resource manager 63 acquires information on the “application 51-3” from the resource availability management table 633b.

In the step ST33, the resource manager 63 identifies a callback destination. The resource manager 63 identifies the application indicated by the information acquired by referring to the resource availability management table 633b as the callback destination and then proceeds to the step ST34.

In the step ST34, the resource manager 63 refers to the execution information management tables. The resource manager 63 refers to the execution information management table in which the application ID indicates the application identified as the callback destination and then proceeds to the step ST35.

In the step ST35, the resource manager 63 updates the execution counter. Since the resource has made the callback request, the resource manager 63 decrements the execution counter as a result of completion of the process corresponding to the execution request and then proceeds to the step ST36.

In the step ST36, the resource manager 63 notifies the application of the callback. The resource manager 63 notifies the application identified as the callback destination of the callback indicating that the process corresponding to the execution request has been completed. For example, when the software codec 81-1 has made a callback request, the resource manager 63 notifies the application 51-3 of the callback indicating that the process corresponding to the encoding instruction has been completed.

As described above, when the resource makes a callback request, the resource manager 63 can refer to the resource availability management table 633b and notify the application having issued the encoding instruction of the callback indicating that the process corresponding to the encoding instruction has been completed.

Further, the resource manager 63 can judge whether or not the process corresponding to the encoding instruction from the application has been completed by referring to the count of the execution counter in the execution information management table 633c.

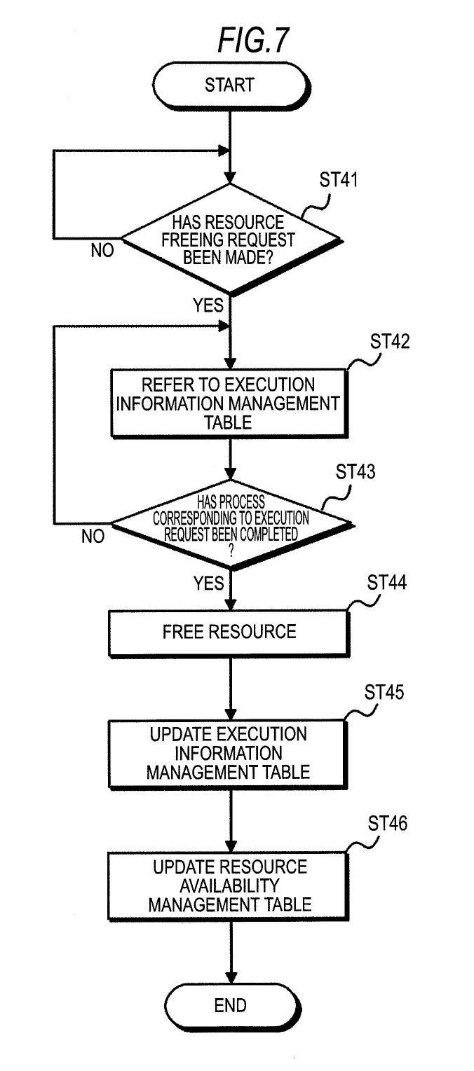

The operation of the resource manager 63 when the application issues a resource freeing instruction as a codec processing request will next be described with reference to the flowchart in FIG. 7.

In the step ST41, the resource manager 63 judges whether or not a resource freeing request has been made. When no resource freeing instruction has been issued, the resource manager 63 returns to the step ST41, whereas when a resource freeing instruction has been issued, the resource manager 63 proceeds to the step ST42.

In the step ST42, the resource manager 63 refers to the execution information management tables. The resource manager 63 refers to the execution information management table in which the application ID indicates the application having made the resource freeing request to acquire the count of the execution counter and then proceeds to the step ST43. For example, when the application 51-3 has made the resource free request, the resource manager 63 refers to the execution information management table 633c-3 shown in Table 5, in which the application 51-3 is described, to acquire the count.

In the step ST43, the resource manager 63 judges whether or not the process corresponding to the execution request has been completed. The resource manager 63 judges whether or not the process corresponding to the execution request has been completed based on the information acquired by referring to the execution information management table. The resource manager 63 returns to the step ST42 when the count shows that the process corresponding to the execution request has not been completed, whereas the resource manager 63 proceeds to the step ST44 when the count shows that the process has been completed. For example, the resource manager 63 increments the execution counter, the initial value of which is set at “0,” when an encoding instruction is issued, whereas the resource manager 63 decrements the execution counter when notified that the process corresponding to the encoding instruction has been completed. In this case, the resource manager 63 returns to the step ST42 when the count is not “0” because the process corresponding to the encoding instruction has not been completed, whereas the resource manager 63 proceeds to the step ST44 when the count is “0” because the process corresponding to the encoding instruction has been completed.

In the step ST44, the resource manager 63 frees the resource. The resource manager 63 frees the resource occupied by the application having made the resource freeing request and then proceeds to the step ST45. For example, when the application 51-3 makes a resource freeing request, the software codec 81-1 occupied by the application 51-3 is freed into an idle resource.

In the step ST45, the resource manager 63 updates the execution information management tables. The resource manager 63 updates the execution information management tables when the occupied resource is freed. The resource manager 63 selects the execution information management table in which the application ID indicates the application having issued the resource freeing instruction and the occupied resource indicates the freed resource, deletes the selected execution information management table, and then proceeds to the step ST46. For example, the resource manager 63 deletes the execution information management table shown in Table 5, in which the application ID indicates the application 51-3 having issued the resource freeing instruction and the occupied resource indicates the freed software codec 81-1.

In the step ST46, the resource manager 63 updates the resource availability management table. The resource manager 63 updates the resource availability management table 633b when the occupied resource is freed to change the occupancy status of the thus freed resource from occupied to unused. For example, when the software codec 81-1 is freed, the occupancy status of the software codec 81-1 in the resource availability management table 633b shown in Table 4 is updated into the resource availability management table shown in Table 2.

As described above, the resource manager 63 frees the resource and updates the execution information management tables and the resource availability management table in response to the resource freeing request. The resource manager 63 can therefore keep the execution information management tables and the resource availability management table up to date.

The resource manager 63 can automatically allocate an idle resource by carrying out the processes described above irrespective of whether the type of resource is, for example, a hardware resource or a software resource. Further, at the time of resource fetching, even when an application does not know the availability of resources, a resource can be allocated. Moreover, when an application makes a resource freeing request, the occupied resource is freed after encoding or decoding is completed, whereby the resource will not be freed in the course of processing. Still further, since the resource manager 63 can mask the control of a resource from an application, each application can perform encoding and decoding via a common interface. The information processing apparatus 10 can therefore readily manages resources by using the resource manager 63.

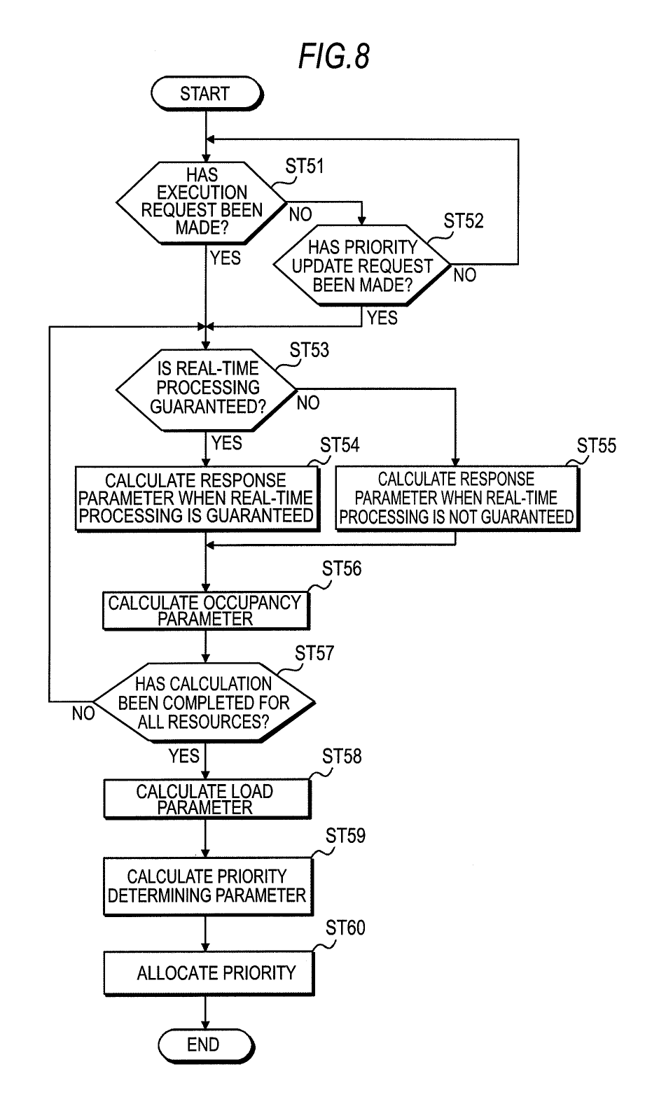

A method for determining the priority that allows an optimum resource to be selected from idle resources will next be described with reference to the flowchart in FIG. 8.

The priority is determined in consideration of

(1) guarantee of real-time processing and execution instruction response time (the period having elapsed from the time when a codec processing execution instruction is issued to the time when the codec processing is completed),

(2) resource occupied period (sum of the periods during which a resource is occupied since an application was activated), and

(3) load factor in software processing (CPU load factor).

The priority is updated whenever an encoding instruction or a decoding instruction is issued or whenever a priority update request is made.

The resource manager 63 uses Equation (1) to calculate a priority determining parameter Ppenalty(n) for determining the priority of a resource(n). In Equation (1), a response parameter Presponse(n) is a parameter on the guarantee of real-time processing and the execution instruction response time for a resource(n). An occupancy parameter Poccupancy(n) is a parameter on the period during which a resource(n) is occupied. Further, a load parameter Pload is a parameter on the load factor in software processing or the CPU load factor. The priority is high when the priority determining parameter Ppenalty(n) is small, whereas the priority is low when the priority determining parameter Ppenalty(n) is large.

P_{penalty}(n)=(Pᵣₑₛₚₒₙₛₑ(n)+P_{occupancy}(n))P_{load} (1)

In the step ST51, the resource manager 63 judges whether or not an execution request has been made. When no encoding or decoding instruction has been issued, the resource manager 63 proceeds to the step ST52, whereas when an encoding or decoding instruction has been issued, the resource manager 63 proceeds to the step ST53.

In the step ST52, the resource manager 63 judges whether or not a priority update request has been made. When no priority update request has been made, for example, from an application, the resource manager 63 returns to the step ST51, whereas when a priority update request has been made, the resource manager 63 proceeds to the step ST53.

In the step ST53, the resource manager 63 judges whether or not real-time processing is guaranteed. When real-time processing is guaranteed, the resource manager 63 proceeds to the step ST54, whereas when real-time processing is not guaranteed, the resource manager 63 proceeds to the step ST55. A case where real-time processing is guaranteed, for example, corresponds to a case where video or audio data are encoded and recorded in real time. A case where real-time processing is not guaranteed, for example, corresponds to a case where real-time processing is not typically required, such as a case where an encoded signal recorded in a recording medium is decoded and converted into another encoded signal in a different format.

In the step ST54, the resource manager 63 calculates the response parameter for the case where real-time processing is guaranteed. The resource manager 63 uses Equation (2) to calculate the response parameter Presponse(n) and then proceeds to the step ST56. When real-time processing is guaranteed, the response parameter Presponse(n) is a parameter that sets a low priority to a resource in which an execution instruction is completed in a response time Tresponse(n) longer than the real time Treal.

$${P}_{response} ( n ) = \{ \begin{matrix}\frac{{T}_{response} ( n )}{{T}_{real}} \text{:} & {T}_{response} ( n ) < {T}_{real} \\ 1 \text{:} & otherwise\end{matrix} \qquad ( 2 )$$

In Equation (2), “Tresponse(n)” represents a codec processing response time for a resource(n). “Treal” represents a minimum response time necessary for real-time processing. For example, for 60p codec processing in which the number of frames per second is 60, Treal is approximately 16 msec.

In the step ST55, the resource manager 63 calculates the response parameter for the case where real-time processing is not guaranteed. The resource manager 63 uses Equation (3) to calculate the response parameter Presponse(n) and then proceeds to the step ST56. When real-time processing is not guaranteed, the response parameter Presponse(n) is a parameter that sets a lower resource priority when the response time Tresponse(n) is longer.

$${P}_{response} ( n ) = \frac{{T}_{response} ( n )}{{\sum }_{1}^{N} {T}_{response} ( n )} \qquad ( 3 )$$

In Equation (3), “Tresponse(n)” represents a codec processing response time for a resource(n). “N” represents the number of resources capable of performing processes corresponding to an encoding instruction (or decoding instruction) having been issued.

In the step ST56, the resource manager 63 calculates the occupancy parameter. The resource manager 63 uses Equation (4) to calculate the occupancy parameter Poccupancy(n) and then proceeds to the step ST57. The occupancy parameter Poccupancy(n) is a parameter that sets a lower priority to a hardware or software resource when the total period during which the resource is occupied by an application is longer during a period from the time when the resource is initialized to the current time.

$${P}_{occupancy} ( n ) = \frac{{T}_{occupancy} ( n )}{{T}_{total}} \qquad ( 4 )$$

In Equation (4), “Toccupancy(n)” represents the total period during which a resource(n) is occupied. “Ttotal” represents the total period having elapsed from the time when the application is activated.

In the step ST 57, the resource manager 63 judges whether or not the calculation described above has been completed for all resources. When the response parameter Presponse(n) and the occupancy parameter Poccupancy(n) have been calculated for all resources, the resource manager 63 proceeds to the step ST58, whereas when the calculation has not been completed for all resources, the resource manager 63 returns to the step ST53.

In the step ST58, the resource manager 63 calculates the load parameter. The load parameter Pload is a parameter that sets a low priority to software resource having a high load factor. The resource manager 63 uses Equation (5) to calculate the load parameter Pload and then proceeds to the step ST59. The load parameter Pload is a parameter that sets a low priority to a software resource when its load factor exceeds a threshold value empirically set in advance.

$${P}_{load} = \{ \begin{matrix}1 \text{:} {L}_{now} < {L}_{th} \\ α \text{:} otherwise\end{matrix} \qquad ( 5 )$$

In Equation (5), “L_{now}” represents the current load factor. “Lₜₕ” represents an acceptable load factor and is, for example, empirically set in accordance with a system of interest. “α” represents a magnification and is, for example, an empirically set value (1<α) when used for a software resource. The load parameter Pload is fixed at “1” when used for a hardware resource. That is, the priority of a hardware resource is calculated based on the response parameter Presponse(n) and the occupancy parameter Poccupancy(n).

In the step ST59, the resource manager 63 calculates the priority determining parameter. The resource manager 63 uses Equation (1) described above to calculate the priority determining parameter Ppenalty(n) and then proceeds to the step ST60.

In the step ST60, the resource manager 63 allocates priorities. The resource manager 63 computes Equation (1) and determines the order of automatically allocated resource priorities. For example, the resource manager 63 determines the order of resource priorities by allocating priorities to the resources based on the priority determining parameter Ppenalty(n) for each of the resources in such a way that a higher priority is given in ascending order of the priority determining parameter Ppenalty(n).

Determining the priorities of the resources as described above eliminates the need for an application to know the state of the system of interest but allows an optimum resource at the current point of time, for example, a resource having the fastest processing speed, to be automatically occupied.

The invention should not be construed as limited to the embodiments thereof described above. The invention is disclosed in the form of embodiments thereof by way of example, and it is obvious that the skilled in the art can modify and substitute the embodiments to the extent that the modification and the substitution do not depart from the spirit of the invention. That is, all the claims should be considered in order to understand the spirit of the invention.

In the information processing apparatus and the resource managing method and program according to embodiments of the invention, the resource manager identifies resources corresponding to a codec processing request from an application based on the first information indicating the relationship between codec processing functions and resources. Further, the resource manager selects an idle resource from the identified resources and allocates the idle resource based on the second information indicating the availability of the resources.

Therefore, an idle resource can be automatically allocated in accordance with the availability of the resources irrespective of whether the type of resource is a hardware resource or a software resource. Further, at the time of resource fetching, even when an application does not know the status of the system of interest, a resource can be allocated, whereby the resource management can be readily carried out. Therefore, a recording apparatus, a reproducing apparatus, an editing apparatus, and other similar apparatus that perform codec processing on, for example, image signals and audio signals are preferably achieved.

The present application contains subject matter related to that disclosed in Japanese Priority Patent Application JP 2009-148786 filed in the Japan Patent Office on Jun. 23, 2009, the entire contents of which is hereby incorporated by reference.

What is claimed is:

1. An information processing apparatus comprising:
a resource manager that allocates a resource in response to a codec processing request from an application,
wherein the resource manager has first information indicating the relationship between codec processing functions and resources and second information indicating the availability of the resources, and
the resource manager identifies resources having the codec processing function corresponding to the codec processing request from the application based on the first information, selects an idle resource from the identified resources based on the second information, and allocates the idle resource.

2. The information processing apparatus according to claim 1,
wherein the resource manager calculates a priority for each of the resources, selects an idle resource having the highest priority, and allocates the selected resource.

3. The information processing apparatus according to claim 2,
wherein the resource manager calculates the priority in consideration of a response time and a resource occupied period, and
the resource manager gives a higher priority to a resource the response time of which is shorter, and gives a higher priority to a resource the occupied period of which is shorter.

4. The information processing apparatus according to claim 3,
wherein the resource manager calculates the priority of a software resource by using a load factor in software processing and gives a higher priority to a resource the load factor of which is lower.

5. The information processing apparatus according to claim 1,
wherein the resource manager updates the second information when the resource is allocated.

6. The information processing apparatus according to claim 1,
wherein the resource manager further has third information indicating a command execution status in the allocated resource, and
when the application issues a resource freeing request, the resource manager frees the resource allocated to the application after the third information indicates that the command execution is completed.

7. The information processing apparatus according to claim 6,
wherein the resource manager updates the third information when the allocated resource notifies the resource manager that the command execution is completed, and updates the second information when the resource allocated to the application is freed.

8. The information processing apparatus according to claim 1,
wherein the resource manager includes a resource controller that controls the resources, and
the resource manager uses the resource controller to control the allocated resource to perform the codec processing in response to the codec processing request from the application.

9. A resource managing method that instructs a resource manager to perform the steps of:
identifying resources having a codec processing function corresponding to a codec processing request from an application based on first information indicating the relationship between codec processing functions and resources; and
selecting an idle resource from the identified resources based on second information indicating the availability of the resources and allocating the idle resource.

10. A program that causes an information processing apparatus to function as:
function means for identifying resources having a codec processing function corresponding to a codec processing request from an application based on first information indicating the relationship between codec processing functions and resources; and
function means for selecting an idle resource from the identified resources based on second information indicating the availability of the resources and allocating the idle resource.
